(19) United States
(12) Patent Application Publication
(10) Pub. No.: US 2008/0006968 A1
(43) Pub. Date: Jan. 10, 2008

(54) HEAT MOLDABLE FLOCK TRANSFER WITH HEAT RESISTANT, REUSABLE RELEASE SHEET AND METHODS OF MAKING SAME

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/842,397

(22) Filed: Aug. 21, 2007

Related U.S. Application Data
(63) Continuation-in-part of application No. 10/394,357, filed on Mar. 21, 2003.
Application No. 10/394,357 is a continuation-in-part of application No. 09/629,746, filed on Jul. 31, 2000, now Pat. No. 6,929,771.
Application No. 10/394,357 is a continuation-in-part of application No. 09/621,830, filed on Jul. 24, 2000.
Application No. 10/394,357 is a continuation-in-part of application No. 09/735,721, filed on Dec. 13, 2000.
(60) Provisional application No. 60/823,072, filed on Aug. 21, 2006.
(60) Provisional application No. 60/366,580, filed on Mar. 21, 2002.
(60) Provisional application No. 60/393,362, filed on Jul. 3, 2002.
(60) Provisional application No. 60/416,098, filed on Oct. 4, 2002.
(60) Provisional application No. 60/443,986, filed on Jan. 30, 2003.

(51) Int. Cl. B32B 33/00

(52) U.S. Cl. 264/511; 428/90

(57) ABSTRACT

A method of decorating a molded article is provided in which a mold insert, the mold insert, comprising a plurality of flock fibers, a heat resistant release sheet, a release adhesive, a permanent adhesive layer, and a forming film is thermoformed. During thermoforming, the heat resistant release sheet is positioned between a surface of a forming mold and the flock fibers to protect the flock fibers from overheating.

### CROSS-REFERENCE TO RELATED APPLICATIONS

The present application (a) claims the benefits under 35 U.S.C. §119(e) of U.S. Provisional Application 60/823,072, filed Aug. 21, 2006, and (b) is a continuation-in-part of U.S. patent application Ser. No. 10/394,357, filed Mar. 21, 2003, which is a continuation-in-part of each of U.S. patent application Ser. Nos. 09/629,746, filed Jul. 31, 2000; 09/621,830, filed Jul. 24, 2000; and 09/735,721, filed Dec. 13, 2000, and claims the benefits under 35 U.S.C.§119 of each of U.S. Provisional Application Serial Nos. 60/366,580, filed Mar. 21, 2002; 60/393,362, filed Jul. 3, 2002; 60/416,098, filed Oct. 4, 2002; and 60/443,986 filed Jan. 30, 2003, each of which is to Abrams and is incorporated herein by this reference in their entireties.

### FIELD OF THE INVENTION

This invention relates generally to flocked articles and specifically to molded articles having flocked surfaces.

### BACKGROUND OF THE INVENTION

It is often desirable to decorate molded plastic parts for aesthetic or practical purposes. Injection molded articles are often decorated using inks, screen printing, pad printing, direct electrostatic flocking and hot stamping. These methods are most often post-molding operations requiring additional processing and cost and time. In addition, the resulting quality of the product is often low, due to the low quality of adhesion or unevenness of the coating.

Recently, In-Mold Decoration (IMD) has been developed to incorporate the application of decoration while the part is being molded to eliminate the extra step of post mold decorating. However, a number of problems have developed with the IMD technology. By way of example, the ink or decoration is easily damaged by high temperatures experienced during thermoforming of the decoration prior to insertion into the mold and during resin injection into the mold. The ink or decoration is often discolored or burned because of this heat, leading to an unacceptable and/or unsalable finished article. Additionally, the polyester carrier sheet typically used during thermoforming and/or molding is a single-use item, thereby increasing operating costs on a per-item basis and reducing the profit realized by the manufacturer of the flocked article.

### SUMMARY OF THE INVENTION

These and other needs are addressed by the present invention. The invention generally provides a flocked molded article with a heat-resistant, reusable release sheet, and methods for producing and utilizing the article.

In one aspect of the present invention, a forming method includes the steps:

(a) providing a mold insert, the mold insert comprising a plurality of flock fibers having opposing first and second ends, a heat resistant release sheet, a release adhesive adhered to the first ends of the fibers and the release sheet, a permanent adhesive layer adhered to the second ends of the fibers, and a forming film, wherein the permanent adhesive layer is positioned between the fibers and the forming film; and

(b) thermoforming the mold insert to form formed mold insert having a desired three dimensional shape, wherein, during thermoforming, the heat resistant release sheet is positioned between a surface of a forming mold and the flock fibers.

To protect against burning or heat damage to the flock fibers, the melting, and optionally the softening, point of the heat resistant release sheet is greater than the temperature experienced by the sheet during thermoforming. Preferably, the release sheet has a melting temperatures of at least about 200° C., even more preferably at least about 225° C., and even more preferably at least about 250° C., and the softening point or glass transition temperature of at least about 65° C., even more preferably at least about 75° C., even more preferably at least about 100° C., and even more preferably at least about 150° C. Preferably, the sheet has a thermal conductivity at 23° C. and heat transfer coefficient of no more than about 0.40 W/(m*K), even more preferably no more than about 0.35 W/(m*K), and even more preferably no more than about 0.30 W/(m*K).

The heat resistant release sheet may be the same or different composition as the resin and/or backing film and more preferably any suitable material, such as polystyrene, an acrylic polymer, polyvinyl, polyolefin, cellulose, polyester, ABS, polypropylene, and polyettrelene, with polycarbonates, silicone and mixtures and composites thereof being even more preferred. In a preferred embodiment, the heat resistant release sheet is the same material as the backing film and displays low electrical resistivity.

The heat resistant release sheet, backing film, and permanent adhesive are preferably a cast or extruded continuous sheet and not woven to permit them to be formed into a three-dimensional shape. A non-permanent release adhesive may be located between the heat resistant release sheet and the flock fibers to adhere the heat resistant release sheet to the mold insert. In a preferred embodiment, the heat resistant release sheet is operable for use and reuse in a plurality of thermoforming and molding operations.

The first permanent adhesive layer may be any suitable adhesive, such as thermoset and thermoplastic adhesives. The permanent adhesive is preferably at least partially (and typically fully) activated before positioning of the mold insert in the mold.

To protect against burning or heat damage to the flock fibers during thermoforming, the heat resistant release sheet preferably has a melting and/or softening point that is at or above the maximum temperatures experienced by the heat resistant release sheet during thermoforming and/or during molding. Similarly, the backing film preferably has a melting point that is at or above the maximum temperature experienced by the backing film during thermoforming and during molding. The heat resistant release sheet may be removed from the mold insert before molding and subsequently reused in other thermoforming and/or molding operations. To provide for melt bonding with the resin, the backing film has a chemical composition compatible with that of the resin.

The present invention has an advantage over conventional IMD processes in that the flock fibers can be protected from burning or heat damage experienced by the high temperatures required by the thermoforming and/or molding processes by the use of a heat resistant release sheet. The present invention can also have the advantage of a reusable heat resistant release sheet, which may be used in a plurality of thermoforming and/or molding processes and therefore decrease the operating costs of the production of molded articles. Additionally, the present invention can be relatively simple and requires, at most, a modest capital investment to implement. These and other advantages and aspects of the present invention will be evident from the discussion herein.

### BRIEF DESCRIPTION OF THE DRAWINGS

FIG. 1 is a side view of an embodiment of a flocked mold insert film according to the present invention;

FIG. 2 is a side view of another embodiment of a flocked mold insert film according to the present invention;

FIG. 3 is a side view of another embodiment of a flocked mold insert film according to the present invention;

FIG. 4 is a side cross-sectional view of a mold insert pre-formed to fit inside of the mold of FIG. 5;

FIG. 5 is a side cross-sectional view of the pre-formed mold insert of FIG. 4 in a closed mold;

FIG. 6 is a side view of a finished molded article from the mold of FIG. 5;

FIG. 7 is a flowchart of the production of a flocked, molded article according to at least one embodiment of the present invention;

FIG. 8 is a cross-sectional view of a mold insert in contact with a forming mold according to an embodiment of the present invention; and

FIG. 9 is a flowchart of the production of a formed mold insert according to an embodiment of the present invention.

### DETAILED DESCRIPTION OF THE INVENTION

In one embodiment, a flock heat transfer type media is used rather than ink-printed film inserts or decorations to provide a plush, evenly-coated, three-dimensional single or multi-colored textured decoration that is molded together with the hot resins when the article is formed. Using flock transfer media, a plushly textured decoration is permanently attached to the surface of the molded article. To accomplish this without the risk of burning or heat damaging the flock fibers, a reusable, heat resistant release sheet is utilized such that it contacts first ends of the flock fibers, which first ends are opposing the ends of the flock fibers contacting the permanent adhesive. The heat resistant release sheet preferably completely covers the flock fibers. The heat resistant release sheet may be utilized during a thermoforming step of the flock transfer media, before it is inserted into the mold, to prevent burning or heat damage to the flock fibers from the temperatures experienced during thermoforming. After thermoforming, the release sheet may be optionally removed in advance of molding, and may be reused in a plurality of subsequent thermoforming operations. The heat resistant release sheet may also be inserted inside the mold, still attached to the transfer media, to prevent burning or damage to the flock fibers from temperatures experienced in the molding process. After molding, the release sheet is removed and may be reused in a plurality of subsequent thermoforming and/or molding operations. The in-mold flock transfer media of the present invention finds particular utility in finished plastic parts where a plush, flocked surface is desired.

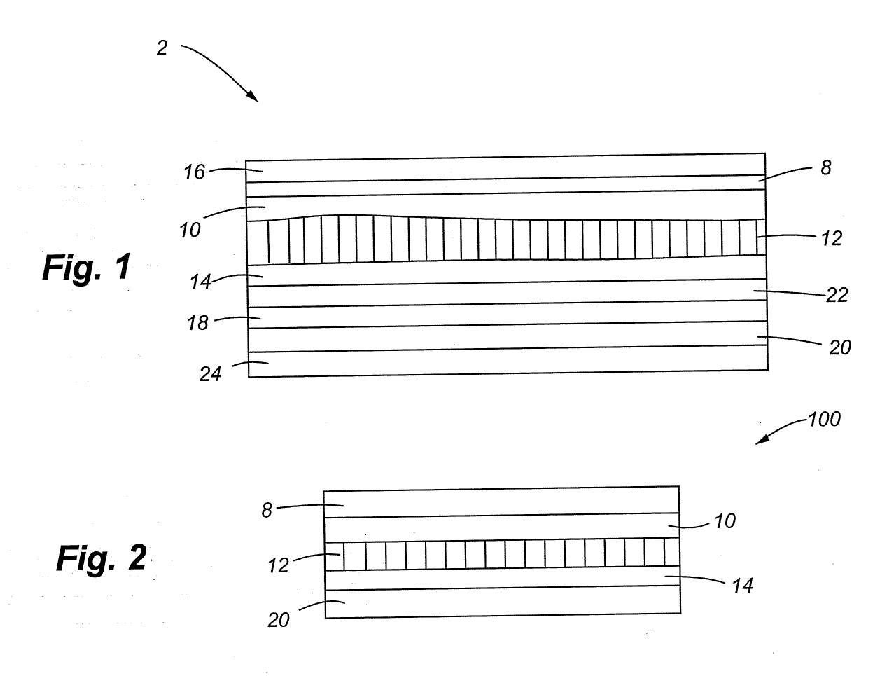

Referring to FIGS. 1-2, various embodiments of the flock transfer (or mold insert) 2 of the present invention are shown. The flock transfer 100 comprises a reusable, dimensionally stable, deformable or flexible, heat resistant release sheet 8 to which a conventional flock transfer release adhesive 10, usually silicone or latex wax, is applied to provide a surface for deposition of the flock fibers 12.

The heat resistant release sheet 8 protects the flock 12 fibers from burning and/or from heat damage that may occur due to the temperatures experienced in the later thermoforming and/or resin injection molding processes. The heat resistant release sheet 8 may be any suitable material that is reusable, heat resistant, thermoformable, dimensionally stable with the flock 12, displays low electrical resistivity, and that has a melting point, and optionally a softening point, at or greater than the temperatures that will be experienced by the release sheet 8 during thermoforming and/or molding. Such suitable materials include, without limitation, thermoplastics, such as polystyrene, acrylic polymers, polyvinyl, polyolefin, cellulose, polyester, ABS, polypropylene, and polyettrelene, as well as mixtures and composites thereof, with polycarbonates and mixtures and composites thereof being preferred. In a preferred embodiment, the heat resistant release sheet 8 is made of material that is chemically and physically similar to the backing film 20. More preferably, both the heat resistant release sheet 8 and the backing film 20 are made of polycarbonate.

The release sheet 8 may also be made of silicone/polysiloxane and/or similar inorganic-organic polymers with the chemical formula [R₂SiO]ₙ, where R=organic functional groups such as hydrogen, methyl, ethyl, and phenyl. Preferably, the polymer selected will be a short flow, visco-elastic solid similar to rubber, such as polydimethylsiloxane and more preferably dimethicone, that has a melting point, and optionally a softening point, greater than the temperatures that will be experienced by the flock transfer 100 during thermoforming and/or molding. Alternatively, the release sheet 8 may be made of a silicone resin of molecular weight in the range of 1,000-10,000 formed by branched, cage-like oligosiloxanes with the general formula of RₙSiXₘO_{y}, where R is a non reactive substituent such as a methyl or a phenyl group, and X is a functional group such as hydrogen, chlorine, an hydroxyl group, or an alkoxyl group, and/or other polymeric sheets which act as elastomers, such as natural rubber, polyisoprene such as butyl rubber, polybutadiene such as styrene butadiene rubber and/or nitrile rubber, chloroprene rubber such as polychloroprene or Neoprene, FKM Viton®, Tecnoflon®, Santoprene®, ethylene propylene rubber, polyurethane rubber, resilin, polyacrylic rubber, epichlorohydrin rubber, polysulfide rubber, and/or chlorosulfonated polyethylene. To provide adequate flexibility during thermoforming, the release sheet 8 preferably has a thickness of no more than about 50 mm, even more preferably no more than about 25 mm, and even more preferably no more than about 15 mm.

In a preferred embodiment, the heat resistant release sheet 8 has a melting point at or greater than, and/or a softening temperature less than, the maximum temperature realized in thermoforming and by the resin injected into the injection mold (and the melting point of the resin) and more preferably greater than the maximum temperature realized by the flock transfer 100 during thermoforming. This temperature can be the same as the softening and/or melting point of the flock fiber 12. Preferably, the melting temperature of the release sheet 8 is at least about 200° C., even more preferably at least about 225° C., and even more preferably at least about 250° C. and the softening point or glass transition temperature of the sheet is at least about 65° C., even more preferably at least about 75° C., even more preferably at least about 100° C., and even more preferably at least about 150° C. Preferably, the sheet 8 has a thermal conductivity at 23° C. and heat transfer coefficient of no more than about 0.40 W/(m*K), even more preferably no more than about 0.35 W/(m*K), and even more preferably no more than about 0.30 W/(m*K). The heat resistant release sheet 8 is preferably a cast or extruded continuous sheet and is not a fabric to permit it to be thermoformed into a three-dimensional shape. Because it is dimensionally stable, the heat resistant release sheet 8 may assist in robotically positioning the flock transfer 100 inside of the mold itself. A vacuum is able to pick up the flock transfer 100 by the heat resistant release sheet 8 and transport and position it at a desired location in the mold.

The temporary release adhesive 10 is selected such that the bonding force between the release adhesive 10 and the flock 12 is less than the bonding force between the permanent adhesive 14 and flock 12 on the backing film 20. In this manner, the release sheet 8 and the temporary release adhesive 10 can be removed, either after thermoforming or after the injection molding process, by simply peeling them off of the flock 12 without causing separation of the flock 12 from the permanent adhesive 14 or the backing film 20. Upon removal, the release sheet 8 can be reused in a plurality of thermoforming and/or molding operations to create additional molded articles. Preferably, the melting point of the temporary release adhesive 10 is at or greater than the maximum temperature experienced by the flock during thermoforming and that is at or greater than the maximum temperature realized by the resin injected into the mold (and the melting point of the resin). As may be appreciated, for a cooled mold, it is possible that the melting point of the temporary release adhesive 10 may be slightly less than the resin temperature.

The permanent adhesive 14 may be any suitable adhesive, with water-, UV-curable, and solvent-based adhesives being preferred. Preferably, the permanent adhesive 14 has a melting point that is greater than the maximum thermoforming temperatures and maximum temperature realized by the resin injected into the mold (and the melting point of the resin) and more preferably greater than the maximum temperature realized by permanent adhesive 14 during the injection molding process (which melting point may be less than the resin temperature for a cooled mold). Particularly preferred adhesives include hot melt thermoplastic and thermosetting adhesives. Thermosetting adhesives solidify or set irreversibly when heated above a certain temperature. This property is usually associated with a cross-linking reaction of the molecular constituents induced by heat or radiation. Thermosetting adhesives can include curing agents such as organic peroxides or sulfur. Examples of thermosetting adhesives include polyethylene, polyurethanes, polyamides, phenolics, alkyds, amino resins, polyesters, epoxides, and silicones. As will be appreciated, thermosetting adhesives have various stages, namely A-stage in which the adhesive has not yet been solidified or set irreversibly; B-stage in which the adhesive is only partially cross-linked; and C-stage in which the adhesive is substantially fully cross-linked.

The flock 12 used in any of the processes discussed herein may be any electrostatically chargeable fiber, such as fibers made from rayon, nylon, cotton, acrylic, and polyesters such as poly(cyclohexylene-dimethylene terephthalate). Preferably, the flock 12 has a melting and/or softening point that is greater than the maximum temperatures realized during thermoforming and by the resin injected into the mold (and the melting point of the resin) and more preferably greater than the maximum temperature realized by the flock 12 during the injection molding and forming processes. Acrylic flock is therefore undesirable in many applications. The flock 12 is also preferably resilient under the pressures experienced in the mold. In most applications, the orientation of the flock 12 is at least substantially orthogonal or perpendicular to the surface of the backing film 20. Resilient flock, such as polyesters (e.g., poly(ethylene terephthalate), PCT, and other terephthalate polymers), and nylon flock, may matt down during molding but, after ejection from the mold, self-restore to the original orientation relative to the backing film 20. An advantage of flock resiliency is thus the ability to compress the flock 12 during molding to avoid “down-gauging” the wall thickness of the finished molded article. Compressible and less resilient flock is desirable in some applications, such as sublimation coloration or dying, but requires additional processing steps to restore such flock to its pre-mold orientation, such as vacuuming or mechanically brushing the flock, applying high voltage, heating to high temperatures, and the like. Finally, it is preferable that the flock 12 have high abrasion resistance and color fastness. Nylon, PCT, and poly(ethylene terephthalate) flock is thus desirable due to its abrasion resistance and color fastness. In contrast, rayon flock, though resilient, is undesirable in certain applications due to relatively poor abrasion resistance and color fastness.

The dimensionally stable substrate or backing film 20 provides stability to the entirety of the flock transfer 100 in that it prevents dislodgment of the flock transfer 100 from the desired position during forming and when in the mold and it prevents the flock 12 from separating from the permanent adhesive 14 during resin injection in the mold. The backing film 20 preferably has a melting point that is at or above the maximum temperature experienced by the backing film 20 during thermoforming (and a softening temperature that is less than the thermoforming temperatures) and while in the closed mold (which may be less than the melting point and maximum temperature of the resin) and is able to provide a melt bond with the resin, and has tensile strength, compressive strength and thermal stability sufficient to withstand the maximum pressures experienced in the closed mold during the molding process without warping or shrinking. The softening and/or melting point of the backing film 20 may thus be higher than the maximum temperature realized by the resin and backing film 20 during molding. As will be appreciated, it is important that the resin be chemically and physically (e.g., thermally) compatible with the backing film 20 to produce a strong melt bond between these two materials and thus an integral article after removal from the closed mold. Preferably, the substrate or backing film is made of a polymeric material comprised of polymers that will melt bond with the polymers in the resin. Exemplary backing films include monomers or polymers of styrene, acrylics, vinyls, olefins, cellulosics, carbonates, esters, polyester, polyethylene, polycarbonate, polypropylene, ABS, and mixtures thereof. A particularly preferred backing film 20 for many resins is a polycarbonate, which enables the backing film 20 to withstand high pressure and high temperature without degrading, cracking, or melting. In a preferred embodiment, the backing film 20 is made of material that is chemically and physically similar to the heat resistant release sheet 8. More preferably, both the heat resistant release sheet 8 and the backing film 20 are made of polycarbonate.

The release sheet 8 and backing film 20 are preferably nonwoven, neither a textile nor a fabric, and in the form of a cast or extruded continuous film. Woven textiles and fabrics can resist thermoforming into a three-dimensional or nonplanar shape due to the weave of the material.

To provide interesting visual effects, prior to the deposition of the permanent adhesive 14, the release adhesive 10 can be coated with flock and/or other suitable design media, which is typically embedded in, or extends into, the permanent adhesive 14. While not wishing to be bound by any theory, it is believed that the permanent adhesive 14, upon application of heat and/or pressure, will melt, penetrate and surround the design media, and activate to form a strong bond. Suitable decorative media are selected so as to be stable at the temperatures experienced in the mold. Examples of design media other than flock include coatings, colors such as pigments or dyes, beads, metallic flakes, glitter, reflective material, inks, etc.

Several processes to manufacture the flock transfer 100 for insertion into the mold are disclosed in U.S. patent application Ser. No. 10/394,357, filed Mar. 21, 2003, which has been previously incorporated by this reference, and each such process is compatible with the present invention.

The flock transfer utilized can be based on any of several conventional and commercially existing flock transfers, including Lextra®, Lextra® II, or Lextra® 3-D type transfer, or flocked roll goods such as those made by the Societe D' Enduction et de Flokage (Laval, France), from which pieces may be cut out and even pre-formed to conform to the shape of one or more molds where the surface of the finished product is not flat.

Referring again to FIG. 1, an optional barrier film 22 may be applied to the free or back side of the permanent adhesive 14 layer. This embodiment may be used for any number of reasons, including if, during lamination, the fully activated permanent adhesive 14 is unable to later attach to the backing film 20. Alternatively, this embodiment may be utilized if the barrier film 22 is present primarily for color in locations where flock is intentionally omitted and may not provide optimal melt bonding to the resin. In this embodiment, a second permanent adhesive 18 is applied to the free side of the barrier film 22, to adhere the barrier film 22 to the backing film 20, thus allowing the barrier film 22 to provide the desired color or colors, and the backing film 20 to provide the necessary melt bonding characteristics for the molding process. The permanent adhesives 14 and 18 can be any suitable adhesive, with activatable adhesives, such as hotmelt thermoplastic or thermoset adhesives, being preferred.

An optional barrier film 22 may be applied to the free or back side of the permanent adhesive 14 layer. This embodiment may be used for any number of reasons, including if, during lamination, the fully activated permanent adhesive 14 is unable to later attach to the backing film 20. Alternatively, this embodiment may be utilized if the barrier film 22 is present primarily for color in locations where flock is intentionally omitted and may not provide optimal melt bonding to the resin. In this embodiment, a second permanent adhesive 18 is applied to the free side of the barrier film 22, to adhere the barrier film 22 to the backing film 20, thus allowing the barrier film 22 to provide the desired color or colors, and the backing film 20 to provide the necessary melt bonding characteristics for the molding process. The permanent adhesives 14 and 18 can be any suitable adhesive, with activatable adhesives, such as hotmelt thermoplastic or thermoset adhesives, being preferred.

Another (second or third) permanent adhesive 24 may be optionally applied to the free (resin contacting) surface of the backing film 20. This is preferably a thermosetting adhesive and may be any of the adhesives mentioned above. It cross-links to the resin and backing film 20 under the temperatures of the resin during molding, providing a permanent bond between the resin and the backing film 20. In this configuration, the transfer 2 is not introduced into the resin mold but is adhered to the molded resin after it is formed.

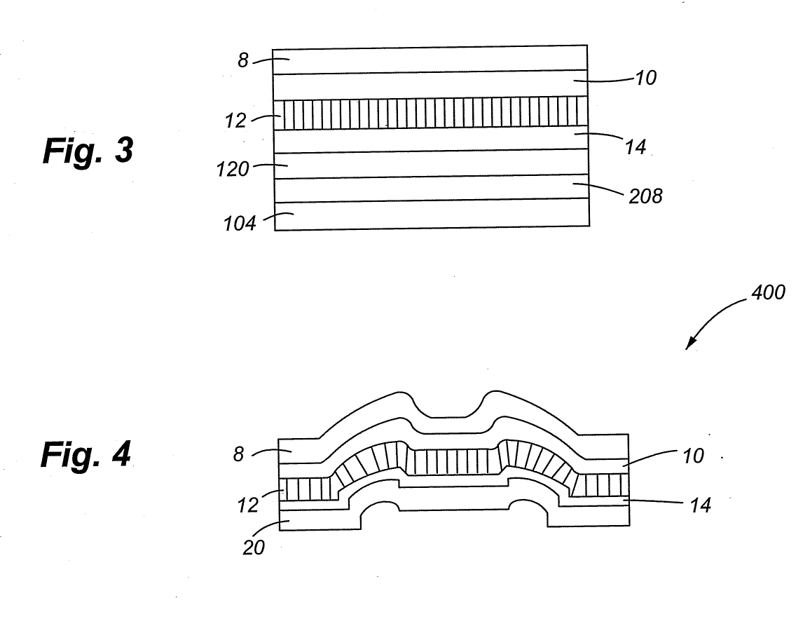

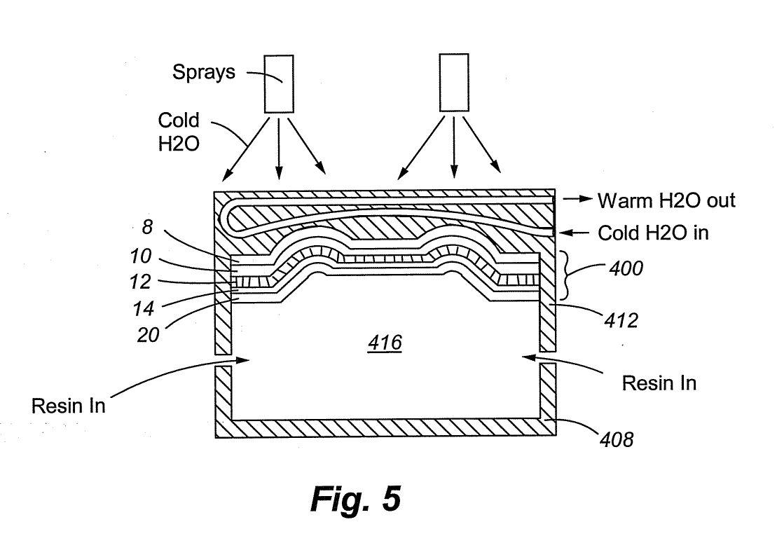

Referring now to FIG. 3, a second layer of permanent adhesive 208 and backing film 104 can be concurrently or later bonded to a barrier film 120, in a manner similar to that described above. The barrier film 120 can provide a desired form of coloration to the transfer when viewed by a customer, e.g., opacity, and/or can be used to provide a desired color in areas where flock 12 is intentionally omitted. This can produce a 3-D appearance to the viewer. Examples of barrier film 120 compositions for this objective include decorative media such as a colored or colorized textile, glitter, reflective glass, beads, etc. The barrier film 120 can also be selected to provide desired physical properties to the flock insert 100. For example, the barrier film 120 can have high tensile and compressive strengths, and thus a low modulus of elasticity, to provide rigidity to the flock insert 100, or a high modulus of elasticity to provide elasticity. This can give the flock insert 100 superior resistance to handling before and during attachment to the backing film 104 and/or more elasticity and therefore more forgiveness or tolerance if the mold insert film is not sized properly relative to the backing film 104. Examples of barrier film 120 compositions for this objective include (foamed) rubber and polyurethane. The barrier film 120 can act as a barrier to migration of the resin 6 and/or the second permanent layer of adhesive 208 into the flock 12. Examples of barrier film 120 compositions for this objective include plastics and metal foils having a melting point higher than the maximum temperatures experienced in the mold. Alternatively, the barrier film 120 can have a low thermal conductivity, or be thermally insulative, to provide a thermal barrier to protect the adhesive/design media located above the barrier film 120 from the high molding temperatures. In this manner, the barrier film 120 acts in a similar capacity as the heat resistant release sheet 8 and both structures will preferably be of the same material. Examples of film compositions for this objective include fiberglass, asbestos, silica, and teflon, but preferably polycarbonate. The permanent adhesives 14 and 208 can be any suitable adhesive, with activatable adhesives, such as thermoset adhesives, being preferred.

Other embodiments of flock transfers that can be used with the present invention include, for example, those described in my patents and patent applications, including but not limited to U.S. Pat. Nos.: 4,810,549; 5,047,103; 5,207,851; 5,346,746; 5,597,637; 5,858,156; 6,010,764; 6,083,332; 6,110,560; U.S. patent applications Ser. Nos.: 09/735,721 filed Dec. 13, 2000; 09/621,830 filed Jul. 24, 2000; 29/058,551 filed Aug. 19, 1996; 09/548,839 filed Apr. 13, 2000; 09/973,113 filed Oct. 9, 2001; and U.S. Provisional Applications Ser. Nos. 60/327,642, filed Oct. 5, 2001, 60/344,862, filed Nov. 8, 2001, and 60/332,647, filed Nov. 21, 2001. The contents of these patents and patent applications are hereby incorporated by this reference, as though filly set forth herein.

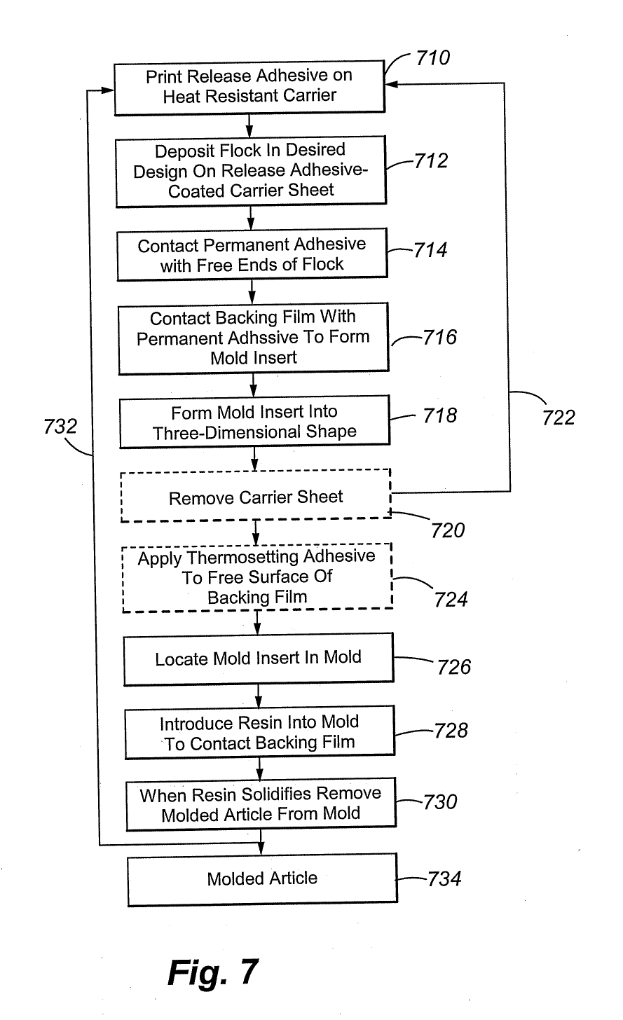

A process for forming an injection molded article comprising the mold insert will now be discussed with reference to FIG. 7.

In steps 710-716, the mold insert is formed.

In step 710, the temporary release adhesive 10 is applied to the release sheet in the reverse of a desired pattern, corresponding to the overall image which is to be flocked and transferred onto the article. Preferably, the release sheet 8 is present such that it covers all of the flock 12 in the flock transfer 100, to prevent burning or heat damage during thermoforming and/or during the molding process; therefore, the flock is preferably applied to the flock transfer 2 such that all of the flock fibers 12 to be transferred to the article are covered by the heat resistant release sheet 8.

In step 712, the flock 12 is applied to the release adhesive 10 in any conventional manner, such as electrostatic techniques, vibration, air flow, gravity, or any combination thereof. The method of applying the flock 12 to the release adhesive 10 will depend upon the transfer to be achieved, such as whether the transfer will consist of one or several colors, whether the transfer will include any non-flock decorations, etc.

In step 714, the lower ends of the flock 12 not in contact with the release adhesive are coated with a permanent binder adhesive 14, such as a water based latex or thermoset or thermoplastic film, which binds the flock 12 into a unit such that the unit comprises a continuous, plush surface.

In step 716, the free surface of the permanent adhesive 14 is contacted with the backing film 20 to promote the adhesion of the transfer to the resin during the injection molding process. In a preferred embodiment, the heat resistant release sheet 8 and the backing film 20 are the same material, preferably a polycarbonate. Preferably, the permanent adhesive 14 and backing film 20 are applied substantially simultaneously by lamination techniques. During lamination, the various layers are heated to a temperature sufficient to fully (C-stage) or partially (B-stage) activate the permanent adhesive 14. Once formed, the flock insert 100 can be cut into desired shapes before or after thermoforming. This process can be continuous using a running web line or discontinuous, by depositing each layer onto the heat resistant release sheet 8 in a desired pattern.

In step 718, the mold insert is formed into a desired three-dimensional shape.

FIG. 4 shows an embodiment of a three dimensional, formed mold insert 400 (or mold insert) according to the present invention, for insertion into a resin injection mold. The depicted flock transfer 400 comprises a reusable, dimensionally stable, deformable or flexible, heat resistant release sheet 8, a temporary release adhesive 10, flock 12, a permanent adhesive 14, and a dimensionally stable substrate or backing film 20, which are formed together into a single, laminated insert as described above. Preferably, the forming technique is thermoforming, or one of the several categories of thermoforming, including vacuum forming, pressure forming, twin-sheet forming, drape forming, free blowing, and/or simple sheet bending.

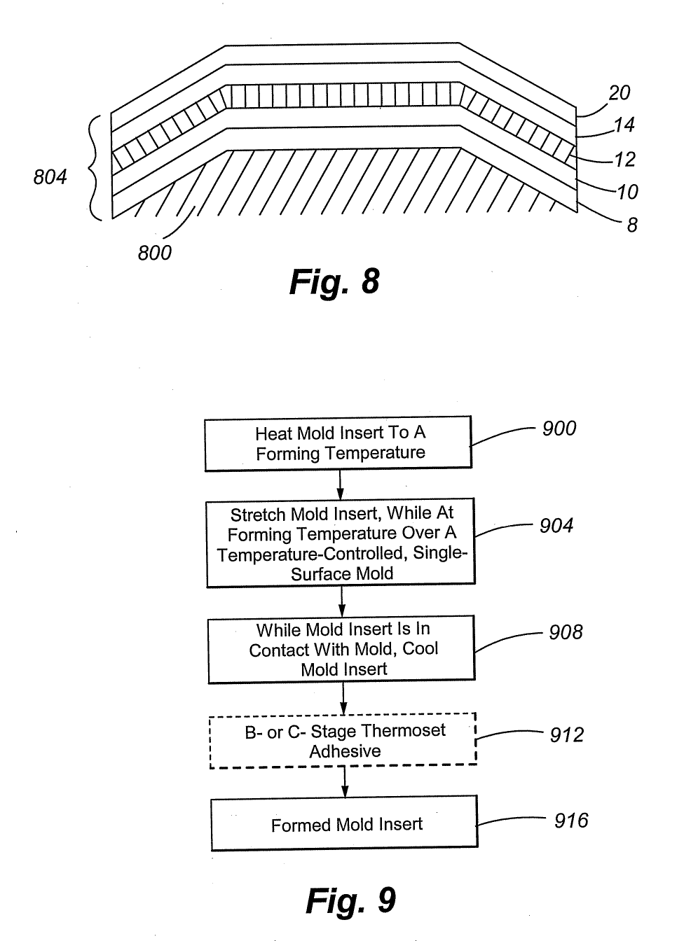

The forming step 718 will now be discussed with reference to FIGS. 8-9.

The mold insert 804 is inserted into the mold in a planar configuration, or can alternatively be formed into a three-dimensional structure for insertion into a mold. This forming can be done by any number of known techniques using heat and/or pressure and/or other forming techniques. Preferably, the forming technique is thermoforming, or one of the several categories of thermoforming, including vacuum forming, pressure forming, twin-sheet forming, drape forming, free blowing, and/or simple sheet bending.

In accordance with one configuration in FIGS. 8-9, the mold insert 804, in step 900, is preferably heated between infrared natural gas or other heaters to at or above the forming temperature of the backing film 20 and, in step 904, stretched over or into a temperature-controlled, single-surface casting mold 800, containing the desired shape or conformation. Cast or machined aluminum is the most common casting mold material, though epoxy and wood tooling are sometimes used for low volume production. In step 908, the mold insert 804 is held against the outer surface of the casting mold 800 until the backing or forming film 20 is cooled, at which point it will retain the shape of the casting mold surface. Once it is cool, the formed mold insert 916 is removed from the forming mold 800, at which point it can be cut to size for precise placement into the resin injection mold. In one implementation, the permanent adhesive 14 is a thermosetting adhesive that is A- or B-staged before steps 900-908. In this implementation, the thermosetting adhesive, in optional step 912, is B- or C-staged, respectively. In another implementation, the permanent adhesive 14 is a thermosetting adhesive that is B- or C-staged prior to step 904. When the adhesive is B-staged before step 904, the adhesive may be C-staged in optional step 912. Step 912 may be performed at the same time as one or more of steps 900-908.

During the thermoforming process, the mold insert 804, and more particularly the flock 12 itself, can be subjected to temperatures high enough to damage the flock 12 fibers. Such damage may include, inter alia, scorching and/or discoloration of the flock 12 fibers. The heat resistant release sheet 8 interposed between the flock fibers 12 and the forming mold 800 protects the flock 12 from such damage by providing a thermal barrier between the flock 12 fibers and the heat source.

In optional step 720, the release sheet 8, together with the release adhesive 10, are removed after thermoforming by peeling the release sheet 8 and the release adhesive 10 from the flock fibers 12. The release sheet 8 may then be reused in subsequent thermoforming operations by removal of any remaining temporary release adhesive 10 and re-initiation of the process described above. Alternatively, the release sheet 8 may be left on the flock transfer 2 and inserted into the injection mold.

After thermoforming, the formed mold insert flock transfer 400 (FIG. 4) preferably fits precisely into corresponding extensions or recesses of the main mold cavity 416 defined by first and second mold components 408 and 412 and is held in place during molding by suitable techniques such as pins, adhesives, vacuum, etc. Alternatively, the flock transfer 400 could be positioned in a mold which does not have the corresponding extensions or recesses, which could produce a result quite different than the result realized when cavity extensions or recesses are employed. For example, the flock fibers 12 could stand less proud of the molded article and would be recessed, inset, or flush with the surface of the solidified resin.

Once inside the (closed) mold, the formed mold insert 400 must be held securely in place to maintain the desired orientation on the finished, molded article. To accomplish this, a relatively weak, pressure-sensitive adhesive 16 can be added to the back surface of the heat resistant release sheet 8 as a separate layer, for the purpose of anchoring the formed mold insert 400 in position inside of the mold. Alternatively, a vacuum can be used to hold the mold insert 400 in place inside the mold. In some applications, the three-dimensional contours of the mold insert match, such as in a male/female relationship, interior three-dimensional features of the mold. In such applications, the pressure of the resin coupled with the matching features can be sufficient to maintain the mold insert in a desired position/orientation without further assistance. Additional means of securing the mold insert 400 in a desired orientation inside of the mold are disclosed in U.S. patent application Ser. No. 10/394,357, which was previously incorporated herein by reference. Preferably, the permanent adhesive 14 is a thermosetting adhesive that has been C-staged before placement into the injection mold.

After the formed mold insert 400 is positioned inside of the injection mold, the injection mold is closed and hot resin is injected into the mold cavity 416. While any of several known methods of injecting hot resin into the mold can be utilized with the present invention, a preferred method of molding is Reaction Injection Molding (RIM), in which two base resins are first mixed together upon entry into the mold. A chemical reaction occurs between the two base resins upon contact, at low heat, which produces the plastic end product. The low heat required for RIM is preferable as it will reduce the potential for burning and heat damage of the flock 12 in the mold. Both mold parts 408 and 412 are constantly cooled, during resin injection, by any suitable technique, such as heat transfer or exchange techniques, to assist in the cooling process of the resin. A particularly preferred technique is to circulate a cooling fluid, such as water, through the upper 408 and/or lower 412 parts of the mold 4. As will be appreciated, other suitable types of molds may be used to form the molded article. Notwithstanding cooling of the mold, the formed mold insert 400, and more particularly the flock fibers 12, may be subjected to temperatures high enough to damage the flock fibers 21. Such damage may include, inter alia, scorching and/or discoloration of the flock fibers 12. The heat resistant release sheet 8 serves to protect the flock 12 from such damage by providing a thermal barrier between the flock fibers 12 and the heat source.

After the resin is injected into the injection mold, the mold continues to be cooled via one of many conventional manners known in the art, such as by circulating cooling water around the exterior of the mold. As the resin cools, it solidifies and forms a permanent melt bond to the permanent adhesive utilized, 14 18 or 24, and/or the backing film 20, as appropriate. When the article is cooled sufficiently the mold may be opened and the article, now integrally containing the mold insert 400, is ejected.

The solidified resin that creates the molded article can be any biodegradable or non-biodegradable moldable material. Preferably, the resin is a condensation or addition polymer having thermoplastic behavior. More preferably, the resin is a high polymer of one or more of a fluorocarbon, hydroxy acid, carboxylic acid, ester, ketone, hydroxy carboxylic acid, tetrafluoroethylene, nylon, phenol, formaldehyde, amide, imide, aryl, ketone, cellulose, ethylene, styrene, urethane, carbonate, isocyanate, vinyl, vinyl chloride, olefin, acetate, propylene, methyl methacrylate, vinyl acetate, ethylene terephthalate, cyclohexylenedimethylene terephthalate, ethylene glycol, terephthalic acid, hexamethylene diamine, sebacic acid, and butylene terephthalate and copolymers, terpolymers, composites, and blends thereof or an amino resin, epoxy resin, acrylic resin, silicones, and ABS resin. The resin can be in the form of a solid, liquid, semi-solid, or semi-liquid when injected into the mold and typically polymerizes in the mold due to a change in heat and/or a chemical reaction. As will be appreciated, a thermoplastic is a high polymer that softens when exposed to heat and returns to its original condition when cooled.

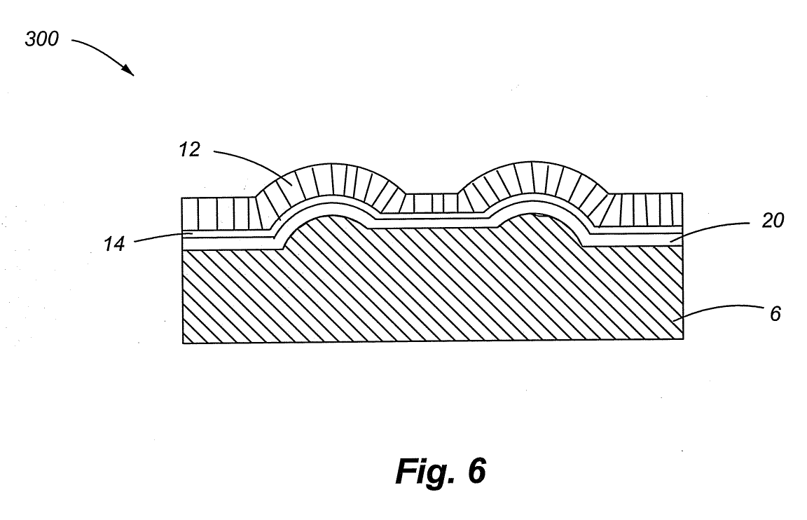

After molding, the release sheet 8 and the release adhesive, if present, are removed from the mold insert 400, revealing a finished, flocked molded article 300 (FIG. 6), where the flock fibers 12 typically stand proud of the exterior surface of the molded article. Upon removal, the release sheet 8 is then available for reuse in subsequent thermoforming and/or molding processes for other molded articles.

The flock transfer/mold insert of the present invention is superior to conventional molded articles using textiles. The differences between a flocked mold insert and a textile mold insert are substantial. A textile is typically woven or knit, continuously constructed, and has a plurality of connected, intermingled, and/or physically overlapped fibers in a multiplicity of transverse, crisscrossed orientations. The disorganized and transverse orientations of the fibers in the textile can have the appearance of a bird's nest. In contrast, a flocked mold insert, due to the precise electrostatic deposition of the fibers, typically has the fibers in parallel orientations perpendicular to the substrate. The fibers typically are at least substantially orthogonal to the planar surface of the backing film. The highly organized density of the fibers provides a plush feel and an attractive appearance. In a flocked mold insert, the fibers can also move independently of one another during the forming process or when being formed or dimensionalized. Additionally, the polyester release sheet typically used in textile mold inserts are single-use sheets unable to withstand the thermal cycling of more than one round of thermoforming and/or molding. The reusable release sheet of the present invention has the advantage of being reusable in a plurality of thermoforming and molding processes, thereby reducing costs as a single release sheet can be used to create a number of molded articles. Additionally, the release sheet of the present invention provides a thermal barrier between external heat sources and the flock fibers, protecting the fibers from damage that can arise from excessive heat.

The flocked mold inserts/transfers of the present invention may be preferred over direct flock insert techniques in certain applications as direct flocked insert articles can suffer from disoriented and loose fibers that can become free during later processing steps and cause problems, particularly in manufacturing electronic products. Transfers, by virtue of the heat resistant release sheet (which protects the transfer from heat damage and which removes disoriented and loose fibers), have a lower incidence of fibers becoming loose in later processing steps, such as trimming or cutting.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

In one alternative embodiment, the permanent adhesive 14 used in mold inserts is a resin dispersion. As will be appreciated, a “resin dispersion” is a dispersion of one or more resins in one or more plasticizers or other additives, which forms a liquid or paste that gels and/or fuses when heated. A resin is an organic polymeric liquid that, when converted to its final state for use, becomes solid. The resin dispersion thus typically includes fine particles of polymers or copolymers and plasticizer(s). The resin dispersion can further include stabilizers, fillers, thickeners, curing agents, etc. The resin dispersion is typically dried and cross-linked with chemical reactions and/or heat.

Preferred resin dispersions include vinyls, such as PLASTISOL™, urethanes, nylons, acrylics, acetates, polyesters, and/or olefins. “Vinyls” refer to a compound including the vinyl grouping (CH₂₋—CH—) or a derivative thereof; “urethanes” to a compound including the grouping CO(NH₂)OC₂H₅ or a derivative thereof; nylons to a compound having the grouping —CONH or a derivative thereof; acrylics to a compound including the acrylonitrile grouping or a derivative thereof; acetates to an ester of acetic acid where the substitution is by a radical; and olefins to a class of unsaturated aliphatic hydrocarbons having one or more double bonds. As noted, the resins in the resin dispersion typically include polymers of the foregoing compounds. Such resin dispersions, though having a low melting temperature, may be usable for low temperature molding techniques.

The resin dispersion is applied to the insert backing film 20 in desired patterns, such as by screen printing of the resin dispersion. The flock 12 will adhere to the backing film 20 only where the resin dispersion is deposited, permitting the formation of novel and attractive free-standing designs. When a resin dispersion is used as the permanent adhesive 14, the resin dispersion and attached backing film 20 are heated or cured, such as in an infrared dryer, to a temperature at or above the gel temperature of the resin dispersion for a time sufficient to pass through both the gel stage (in which the resin dispersion partially solidifies or begins to solidify) and the fusing stage (in which the resin dispersion fully solidifies). Typically, once the resin dispersion is fused the resin dispersion will not melt at the temperatures experienced in the mold. Thereafter, the heat resistant release sheet 8 and the temporary adhesive 10 may be applied, using standard techniques.

As will be appreciated, the gel temperature or gel point is the temperature at which the resin dispersion starts to become a solid. The gel point of a resin dispersion determines how fast the resin dispersion will flash at a given thickness.

The fusion temperature of a resin dispersion is that temperature necessary to completely fuse the resin dispersion. This temperature is typically dictated by the resins and plasticizers in the formulation and is typically (320)(dwell or residence time)° F./160° C. Typically, the heating temperature is at least about 340° F. and more typically ranges from about 320° F. to about 370° F. The residence time is typically at least about 0.5 minute and more typically ranges from about 1 to about 3 minutes.

In yet another embodiment, any number of molding techniques are employed. As will be appreciated, “molding” normally refers to creating a plastic or rubber article in a desired shape by application of heat and/or pressure, either in a negative cavity or in contact with a contoured metal or phenolic surface. Exemplary molding techniques that can be used with the present invention include, but are not limited to, high pressure injection molding, gas-assisted injection molding, fusible core injection molding, low pressure injection molding (including laminate molding and liquid-gas assist molding), advanced blow molding, blow molding, compression molding, thermoplastic sheet composite processing, reactive liquid composite molding, microcellular plastics, lamellar injection molding, and multimaterial, multiprocess technology, rotational molding, co-injection, in-mold decoration, encapsulation, stack molding, micro-injection molding, fusible core, vibration-assisted, injection molding extrusion, surface replication, direct compounding, vacuum forming, transfer molding, or any combination thereof. The finished plastic part need not be a flat plane, but by virtue of the flexibility of the flock transfer may be rounded, or portions of the part may be raised.

In other embodiments, the flock 12 used in any of the above processes is a printable flocking material. Typically, the flocking material is a white polyester or other synthetic fiber. A suitable ink or pigment is then applied to the decorative insert media to cause dying or coloration of the insert media after application to the underlying (or overlying) layer (depending on the order in which the various layers are deposited). Flock coloration techniques include the use of sublimation inks (as noted above), acid dye inks, and pigment inks. Sublimination is often a preferred technique to provide desired color patterns to the design due to the more superior feel of the design. The colored fibers in the design have a softer feel than fibers colored using other techniques, which is more attractive to consumers in many applications. The ink is more colorfast on the fiber as the ink is absorbed by the fiber as opposed to simply being a surface coat on the fiber. Non-sublimation inks, such as acid dye inks, generally must be cured after application, such as by steam curing, which can be impractical and cumbersome.

Other methods of coloring the flock include inkjet printing and other printing techniques. Inkjet printing is particularly attractive. When combined with the various flocking/molding techniques set forth above, it is possible to obtain a wide format design inexpensively and in high volumes. Such designs are particularly attractive when combined with highly resilient flock.

In other embodiments, the above techniques are used with other deposition techniques. For example, the various layers can be deposited by sheet fed processing methods or continuous webline-type processing. In one process configuration, the adhesive is deposited using a small coating machine (e.g., a roller coater, knife-over-roll, etc.). The decorative media can then be applied by any suitable technique mixed media typically is separated by physical imaging techniques such as by screen printing, by using mold inserts, by using templates, and the like.

In yet another embodiment, the decoration on the molded insert article is dimensionalized such as by a foam backing material located beneath or as part of the decoration. There are several techniques of applying the foam backing material. First, the backing film can itself be or be configured as a composite including a foam material. Second, the adhesive film 14 (FIG. 1) or 208 (FIG. 3) can include one or more commonly used blowing agents. When the adhesive film is heated, the blowing agent will produce a gas, which will cause the resin film to form an open and/or closed cell foam structure. In either event, the mold insert is preferably received within a suitable sized recess inside the mold to provide the foam backing material room in which to reside and/or expand.

In yet another alternative embodiment, the backing film may be omitted, such as from a transfer. In this embodiment, the transfer is positioned in the mold, and resin is introduced into the mold at a low pressure and/or flow rate to avoid damaging or dislodging the transfer. The flow rate is controlled by resisting resin flow into and through the mold using a compressible fluid such as a gas (a “gas assist” process). In other words, a compressible fluid is introduced into the mold prior to or during resin injection, and the pressure of the fluid adjusted dynamically to produce a desired rate of resin flow into and through the mold. Typically, the resistant pressure exerted by the compressible fluid on the resin is around 200 psi. This process can be implemented using technology known as the INTELLIMOLD™ process.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of decorating a molded article comprising:
(a) providing a mold insert, the mold insert comprising a plurality of flock fibers having opposing first and second ends, a heat resistant release sheet, a release adhesive adhered to the first ends of the fibers and the release sheet, a permanent adhesive layer adhered to the second ends of the fibers, and a forming film, wherein the permanent adhesive layer is positioned between the fibers and the forming film; and
(b) thermoforming the mold insert to form formed mold insert having a desired three dimensional shape, wherein, during thermoforming, the heat resistant release sheet is positioned between a surface of a forming mold and the flock fibers.

2. The method of claim 1, further comprising:
(c) positioning the flock fibers, permanent adhesive layer, and forming film in a mold; and
(d) introducing resin into the mold, such that a resin bonds to the forming film and forms a molded article, wherein a melting point of the permanent adhesive layer is greater than a temperature of the resin during the introducing step.

3. The method of claim 1, further comprising:
(c) removing and reusing in step (b) the heat resistant release sheet in connection with a second mold insert.

4. The method of claim 2, wherein the heat resistant release sheet is removed prior to step (c).

5. The method of claim 2, further comprising:
(e) removing the heat resistant release sheet after step (d); and
(f) reusing in step (b) the heat resistant release sheet in connection with a second mold insert.

6. The method of claim 1, wherein the heat resistant release sheet is a thermoplastic having a softening temperature below a thermoforming temperature of step (b) and a melting point above the thermoforming temperature.

7. The method of claim 6, wherein the forming film and heat resistant release sheet are primarily composed of a common thermoplastic polymer.

8. The method of claim 7, wherein the thermoplastic polymer is polycarbonate.

9. The method of claim 1, wherein the heat resistant release sheet has a melting temperature of at least about 200° C., a thermal conductivity at 23° C. of no more than about 0.40 W/(m*K), and a heat transfer coefficient of no more than about 0.40 W/(m*K)

10. The method of claim 1, wherein the heat resistant release sheet and backing film comprise, as a primary component, a polymer selected from the group consisting essentially of polystyrene, polyacrylic, polyvinyl, polyolefin, cellulose, Acrylonitrile-Butadiene-Styrene (ABS), polypropylene, polyettrelene, polycarbonates, inorganic-organic polymers having the chemical formula [R₂SiO]ₙ, where R is an organic functional group and mixtures and composites thereof.

11. A molded article formed by the process of claim 2.

12. A thermoformed article, comprising:
a plurality of flock fibers having opposing first and second ends;
a heat resistant release sheet;
a release adhesive adhered to the first ends of the fibers and the release sheet;
a permanent adhesive layer adhered to the second ends of the fibers; and
a forming film, wherein the permanent adhesive layer is positioned between the fibers and the forming film and wherein the forming film has a three-dimensional thermoformed shape.

13. The article of claim 12, further comprising:
a single-surface casting mold engaging the heat resistant release sheet to impart the three-dimensional shape to the forming film.

14. The article of claim 12, wherein the heat resistant release sheet is a thermoplastic having a softening temperature below a thermoforming temperature of step (b) and a melting point above the thermoforming temperature.

15. The article of claim 12, wherein the forming film and heat resistant release sheet are primarily composed of a common thermoplastic polymer.

16. The article of claim 15, wherein the thermoplastic polymer is polycarbonate.

17. The article of claim 12, wherein the heat resistant release sheet has a melting temperature of at least about 200° C., a thermal conductivity at 23° C. of no more than about 0.40 W/(m*K), and a heat transfer coefficient of no more than about 0.40 W/(m*K)

18. The article of claim 12, wherein the heat resistant release sheet and backing film comprise, as a primary component, a polymer selected from the group consisting essentially of polystyrene, polyacrylic, polyvinyl, polyolefin, cellulose, Acrylonitrile-Butadiene-Styrene (ABS), polypropylene, polyettrelene, polycarbonates, inorganic-organic polymers having the chemical formula [R₂SiO]ₙ, where R is an organic functional group and mixtures and composites thereof.

19. A method of forming a three dimensional molded article, comprising:
providing a substantially planar mold insert comprising flock having opposing first and second ends, a heat resistant release sheet, a layer of a release adhesive bonding first ends of the flock to the release sheet, a shape forming film, and a layer of a permanent adhesive bonding second ends of the flock to the shape forming film;
heating the mold insert to a forming temperature;
while at the forming temperature, contacting the mold insert with a temperature-controlled, single-surface mold;
maintaining the mold insert in contact with the single-surface mold until cooled to form a formed mold insert; and
thereafter removing the formed mold insert from the temperature-controlled, single-surface mold.

20. The method of claim 19, further comprising:
positioning the formed mold insert in an injection mold, a shape of the formed mold insert matching a shape of an interior surface of the injection mold;
while the formed mold insert is positioned in the mold, closing the injection mold;
introducing a molten resin in to a cavity in the mold, a surface of the cavity being defined by the forming film of the formed mold insert; and
after a determined period of time, removing a molded article from the mold, the molded article comprising the resin bonded to the forming film, the permanent adhesive, and the flock.
